(19) United States
(12) Patent Application Publication
(10) Pub. No.: US 2008/0134249 A1
(43) Pub. Date: Jun. 5, 2008

(54) CHANNEL CONTROL METHOD FOR IPTV SERVICE AND APPARATUS THEREOF

(76) Inventors: Sun Hee YANG, Daejeon (KR); Kee Seong CHO, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/947,528

(22) Filed: Nov. 29, 2007

(30) Foreign Application Priority Data
Dec. 1, 2006 (KR) 10-2006-0120729
Sep. 4, 2007 (KR) 10-2007-0089327

(51) Int. Cl. H04N 5/00

(52) U.S. Cl. 725/46

(57) ABSTRACT

A channel control method and apparatus for an IPTV service are provided. In order to search for and select channels according to program viewing preference of a user, the channel control method for an IPTV service includes: mode setting operation setting a favorite channel mode and a basic channel mode by analyzing channel change; a favorite channel control operation selecting channels for favorite programs by searching for only the favorite programs in the favorite channel mode; a basic channel control operation selecting the channels by searching for all the programs in a sequential order in the basic channel mode; and a stream providing operation providing streams of the selected channels. Accordingly, at the time of service log-in, the favorite program is automatically connected according to the program viewing preference and reservation, so that it is possible to simplify a channel control operation of the user and to improve service performance with prevention of occurrence of excessive channel change requests.

### CROSS-REFERENCE TO RELATED APPLICATIONS

This application claims the priority of Korean Patent Application No. 10-2006-0120729 filed on Dec. 1, 2006, in the Korean Intellectual Property Office and Korean Patent Application No. 10-2007-0089327 filed on Sep. 4, 2007, in the Korean Intellectual Property Office, the disclosure of which is incorporated herein by reference.

### BACKGROUND OF THE INVENTION

1. Field of the Invention

The present invention relates to an Internet protocol television (IPTV) service system, and more particularly, to a channel control method for an IPTV service capable of searching and selecting a channel according to a user's program viewing preference and an apparatus thereof.

This work was supported by the IT R&D program of MIC/IITA [2005-S-058-01, Development of Network/Service Control Technology in All-IP based Converged network]

2. Description of the Related Art

In a conventional channel control method for an IPTV service, an electronic program guide (EPG), that is, a menu-based method has been used.

The conventional channel control method may be used suitably for a small number of IPTV channels. However, in case of a large number (hundreds or thousands) of IPTV channels, the conventional method is very inefficient. Users need to search for program information one by one inconveniently.

Generally, in case of broadcast programs, user's viewing preference for specific programs is specified according to days of the week. However, in the conventional channel control method, the user's viewing preference is not suitably considered, so that the user needs to search for a desired program by excessively changing channels inconveniently.

In addition, in the IPTV service network, load caused from excessive channel change requests is increased, so that performance thereof may be deteriorated. In addition, since a response time for the channel change requests is increased, a degree of service satisfaction of the user may be lowered.

### SUMMARY OF THE INVENTION

In a conventional channel control method for an IPTV service, since a user's viewing preference is not suitably considered, channel change requests are unnecessarily increased. Since a response time for the channel change requests is increased, a degree of service satisfaction of the user may be lowered.

According to a first aspect of the present invention, the re is provided a channel control method for an IPTV service, comprising: a mode setting step setting a favorite channel mode and a basic channel mode by analyzing channel change; a favorite channel control step selecting a channel for favorite programs by searching for only favorite programs in the favorite channel mode; a basic channel control step selecting the channel by searching for all programs in a sequential order in the basic channel mode; and a stream providing step providing stream of the selected channel.

According to the second aspect of the present invention, the re is provided a favorite program profile managing method in an IPTV service system, comprising: an analyzing step analyzing a request of an IPTV session management apparatus; a registration step, if the request is a registration request of a specific program, acquiring a favorite program profile corresponding to a registration-requested day of the week and registering the specific program; a searching step, if the request is a favorite program searching request, acquiring a favorite program profile corresponding to a search-requested day of the week and acquiring favorite programs according to program preference in a search-requested time period; a reservation step, if the request is a favorite program reservation request, reserving and registering a to-be-reserved program in a favorite program profile corresponding to a reservation-request day of the week.

According to a third aspect of the present invention, the re is provided an IPTV service system comprising: a IPTV service controller searching for only favorite programs in an order of time-based preferences at the time of a channel change request according to a favorite channel mode to select channels, sequentially searching for all the programs of all the channels to select channels, and, after that, configuring multicast forwarding information; an IPTV application server transmitting channel streams to provide an IPTV service; and an IPTV transmission network performing channel branching based on the multicast forwarding information.

According to a fourth aspect of the present invention, the re is provided an IPTV terminal comprising: a channel control apparatus searching for all programs of all channels to select channels or searching for only favorite programs in an order of time-based preferences to select the channels; an IPTV set-top box accessing an IPTV service system and receiving steams of the selected channels from the IPTV service system; and a reproduction apparatus reproducing the streams of the selected channels.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating a configuration of an IPTV service system according to an embodiment of the present invention;

FIGS. 2A to 2E are views illustrating structures of profiles and information according to an embodiment of the present invention;

FIGS. 3A to 3E are flowcharts illustrating a channel control method for an IPTV service according to an embodiment of the present invention;

FIG. 4 is a flowchart illustrating a favorite program profile managing method according to an embodiment of the present invention;

FIG. 5 is a flowchart illustrating a favorite program searching method according to an embodiment of the present invention; and

FIG. 6 is a flowchart illustrating a multicast channel branching method according to an embodiment of the present invention.

### DETAILED DESCRIPTION OF THE PREFERRED EMBODIMENT

Hereinafter, exemplary embodiments of the present invention will now be described in detail with reference to the accompanying drawings. The embodiments of the present invention may be modified in various forms, and the scope of the present invention is not limited to the embodiments. The embodiments of the present invention are provided in order that the ordinarily skilled in the art can have the better understanding of the present invention.

In the accompanying drawings, elements having similar functions and operations are denoted by the same reference numerals.

For better understanding of the present invention, a data output method of a conventional VoIP (Voice over Internet Protocol) phone is firstly described.

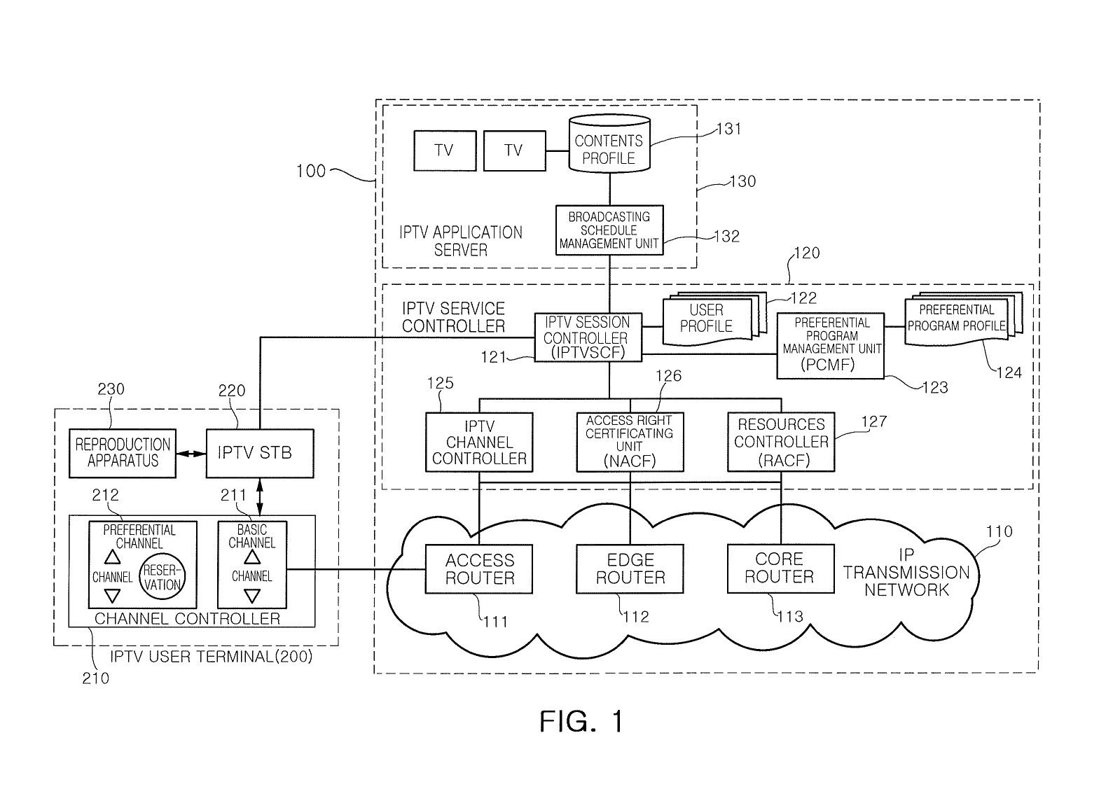

FIG. 1 is a view illustrating a configuration of an IPTV service system according to an embodiment of the present invention.

As shown in FIG. 1, the IPTV service system 100 includes an IPTV transmission network 110, an IPTV service controller 120, and an IPTV application server 130. An IPTV terminal 200 is connected to the IPTV service system 100.

The IPTV transmission network 110 includes an access router 111 for processing switching of broadcasting channels, an edge router 112 and a core router 113 for configuring multicast trees for channels between the IPTV application server 130 and the IPTV terminal 200.

Particularly, according to the present invention, the access router 111 process channel branching based on information (for example, multicast forwarding information including multicast IPs, port numbers, user IP addresses, and the like) provided by the IPTV channel controller 125 of the IPTV service controller 120 instead of a conventional group managing message (generated according to a Internet group management protocol (IGMP)).

The IPTV service controller 120 includes an IPTV session controller (IPTVSCF) 121, a user profile 122, a favorite program management unit (PCMF) 123, a favorite program profile 124, an IPTV channel controller (CHNCF) 125, a access right certificating unit (NACF) 126, and a resources controller (RACF) 127.

The IPTVSCF 121 checks user's requests and service environment by using interaction with IPTV terminal 220 and the user profile 122 and monitors a session state of broadcasting channel access of the user to collect and manage viewing history information. The user profile 122 stores information on the users used for viewing the broadcasting channel. The PCMF 123 checks viewing preference for programs according to time from the viewing history information of the IPTVSF 121 to configure the favorite program profile 124 and searches and notifies the favorite program in response to the request of the IPTVSF 121. The favorite program profile 124 stores information on the favorite programs according to days of the week and time periods. The CHNCF 125 controls multicast channel branching according to the channels. NACF 126 sets network access environment of the users so as to securely transmit IPTV broadcasting contents with a quality of contents maintained. RACF 127 allocates a bandwidth for transmission of streams according to the channel.

The IPTV application server 130 includes a contents profile 131 which stores information on broadcasting starting time and broadcasting ending time for contents according to the channel and a broadcasting schedule management unit 132 which selects and transmits to-be-broadcasted contents according to time periods based on the broadcasting schedule.

The IPTV terminal 200 includes a channel control apparatus 210 which changes the channels in a increment-decrement manner or in an order of program-viewing preferences of a user, an IPTV settop box 220 which performs access to the IPTV service controller 120 and the IPTV transmission network 110, and a reproduction apparatus 230.

The channel control apparatus 210 includes a basic channel controller 212 and a favorite channel controller 211. The basic channel controller 212 requests for channel change in a conventional increment-decrement manner.

The favorite channel controller 211 request for channel change according to viewing preferences corresponding to broadcasting time periods (time-based viewing preference). The favorite channel controller 211 includes a reservation button as well as channel increment and decrement buttons to request for reservation of a viewing program in a broadcasting time of the program. At the time on the days of the week of the reserved program, the program is viewed with priority.

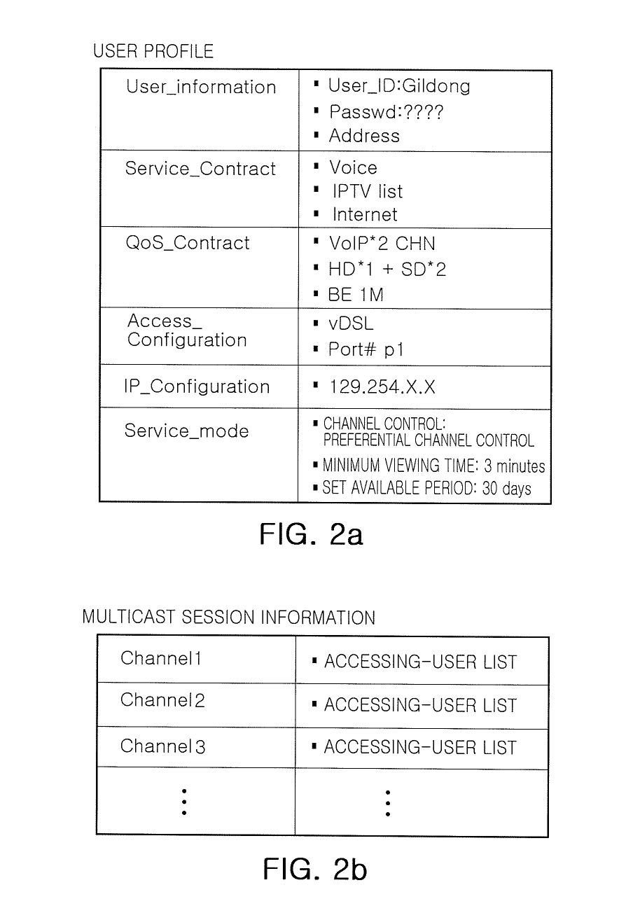

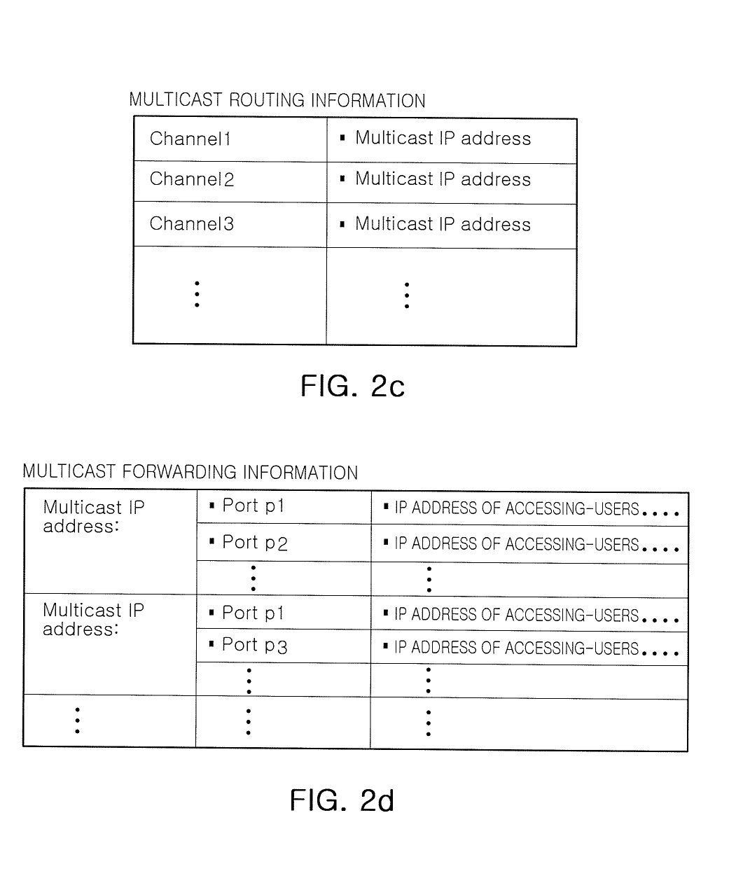

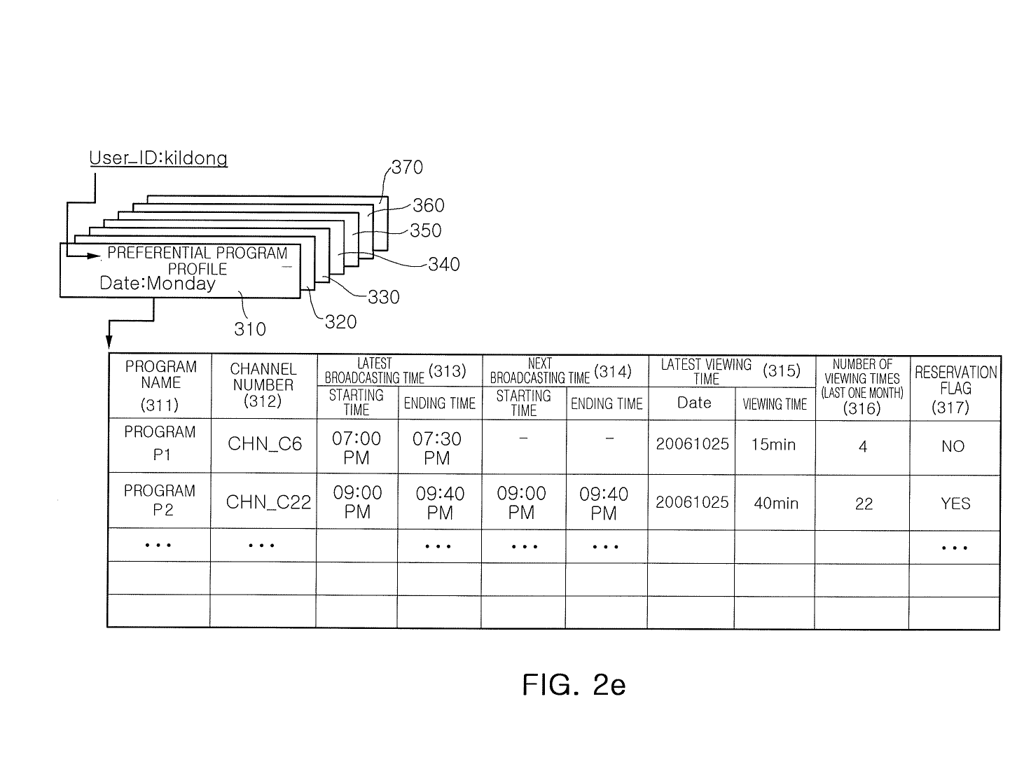

FIGS. 2A to 2E are views illustrating structures of profiles and information according to an embodiment of the present invention. FIG. 2A illustrates a user profile. FIG. 2B illustrates multicast session information. FIG. 2C illustrates multicast routing information. FIG. 2D illustrates multicast forwarding information. FIG. 2E illustrates a favorite program profile.

Referring to FIG. 2A, the user profile stores user information used for user authentication, service contract information used for notifying a contracted service, QoS contract information used for notifying a contracted quality of service (QoS), access configuration information used for notifying an IP address, IP configuration information used for notifying a user's IP address, and service mode information used for notifying a default channel mode, a minimum viewing time, and a set available period.

The user profile is maintained and managed by IPTVSCF 121. When the IPTV terminal 200 logs in, the user profile is loaded on the IPTVSCF 121.

Referring to FIG. 2B, the multicast session information includes user lists of users accessing the currently-serviced IPTV channels. The multicast session information is managed by IPTVSCF 121.

Referring to FIG. 2C, the multicast routing information includes multicast IP address information corresponding to currently-serviced IPTV channels. The multicast routing information is managed by the CHNCF 125.

Referring to FIG. 2D, the multicast forwarding information includes port information on the ports allocated to the multicast IP addresses and the IP addresses of the user accessing the ports. Namely, the multicast forwarding information includes information on branching of the multicast streams to the users accessing the ports.

The multicast forwarding information is managed by the CHNCF 125. The multicast forwarding information is provided to the access router 111. The access router 111 performs channel branching based on the multicast forwarding information.

Referring to FIG. 2E, a plurality of the favorite program profiles 310 to 370 corresponding to the users and the days of the week are provided. Each of the favorite program profiles 310 to 370 stores a program name 311, a channel number 312, a latest broadcasting time 313, a next broadcasting time 314, a latest viewing time 315, a number of viewing times 316, and a reservation flag 317 in a mapping manner.

The program name 311 stores identification information of the favorite programs. The channel number 312 stores identification information for the channel of broadcasting each of the programs. The latest broadcasting time 313 stores starting time and ending time of the most recent broadcasting of each of the programs. The next broadcasting time 314 stores starting and ending time of the next broadcasting of each of reservation-activated programs. The information 311 to 314 is provided by the IPTV application server 130.

The latest viewing time 315 stores the latest viewing date and a total viewing time corresponding to the IPTV terminal 200. The number of viewing times 316 stores the number of viewing times for the program within the set available period. The reservation flag 317 stores reservation status of the program. The information 315 to 317 is provided from the IPTVSCF 121.

In the present invention, the preference for the programs is determined in an order of reserved programs, a most frequently viewed program, an earliest starting program among the reserved programs, and an earliest starting program among non-reserved programs.

The PCMF 123 searches and selects a favorite program from the favorite program profile according to the preference and provides information on the selected favorite program to the IPTVSCF 121.

The IPTVSCF 121 does not register a program of which a total viewing time is shorter than a minimum viewing time (for example, five minutes) as the favorite program, so that it is possible to prevent a temporarily-viewed program at the time of channel zapping from being registered as the favorite program. In addition, the IPTVSCF 121 clears a program of which latest viewing data is beyond a set available period (for example, one month) from the favorite program profile.

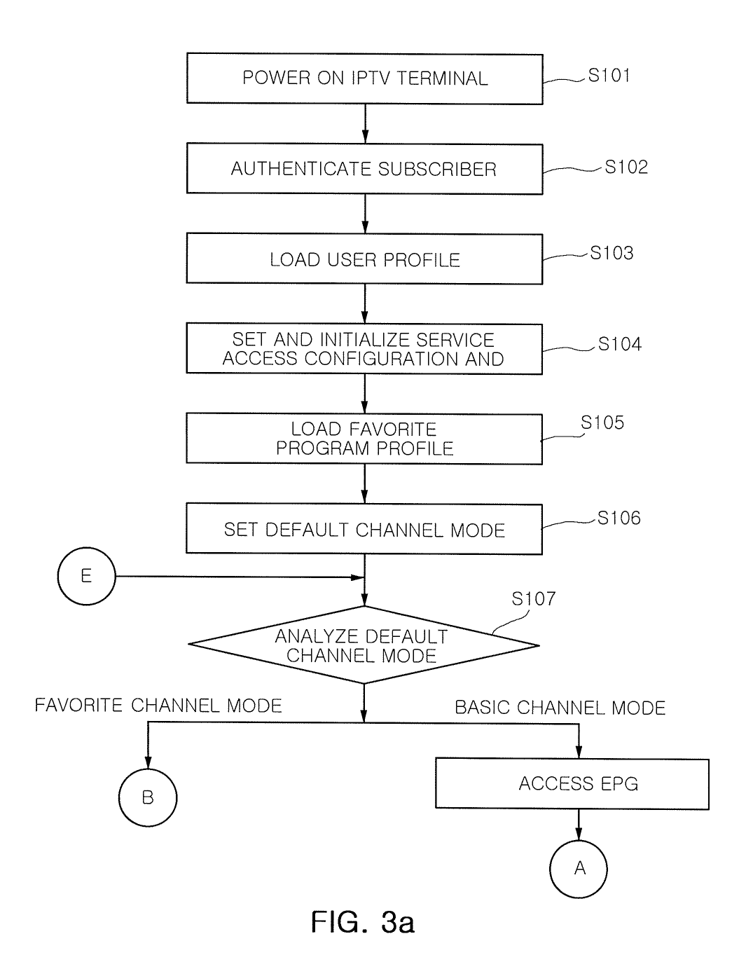

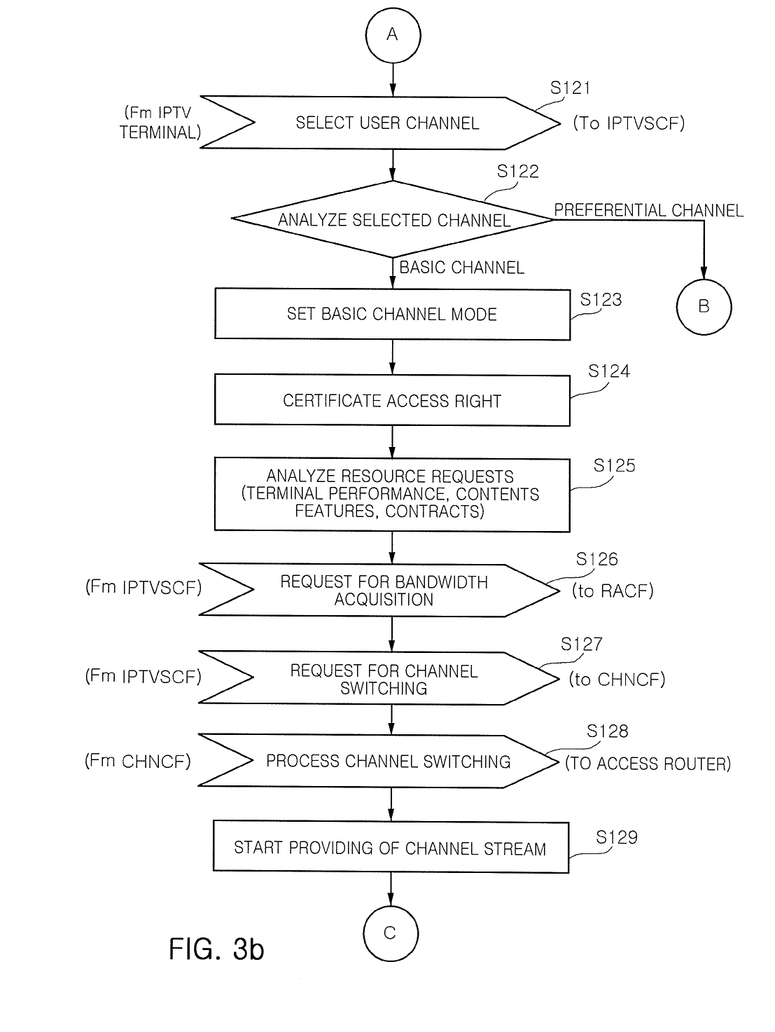

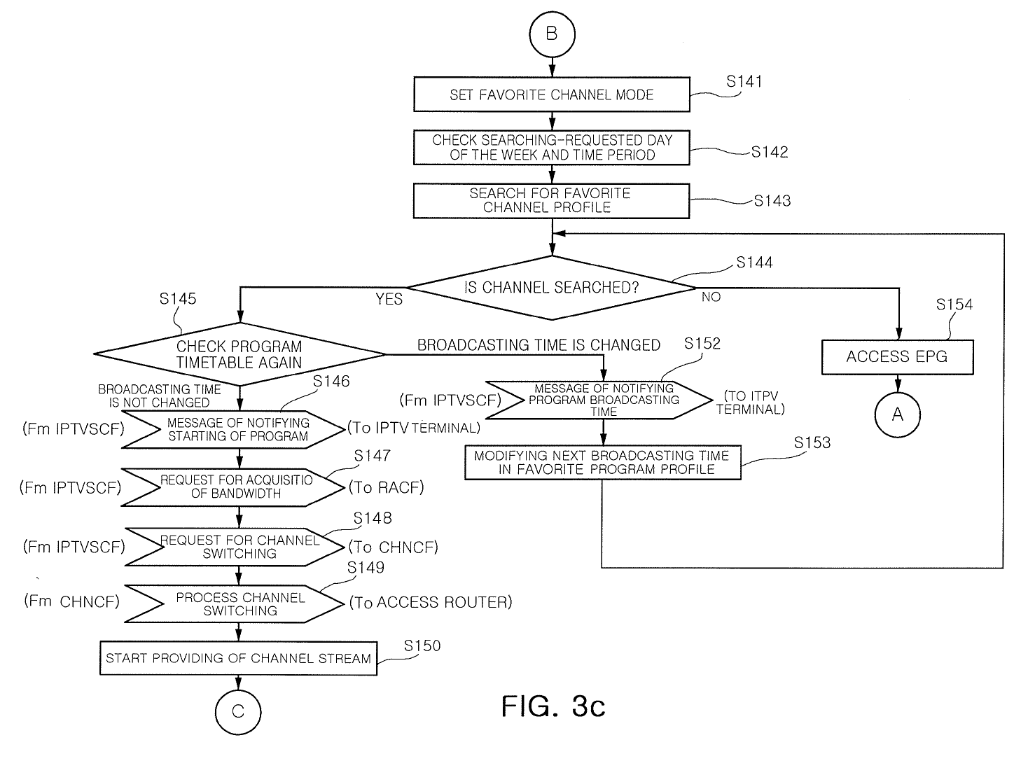

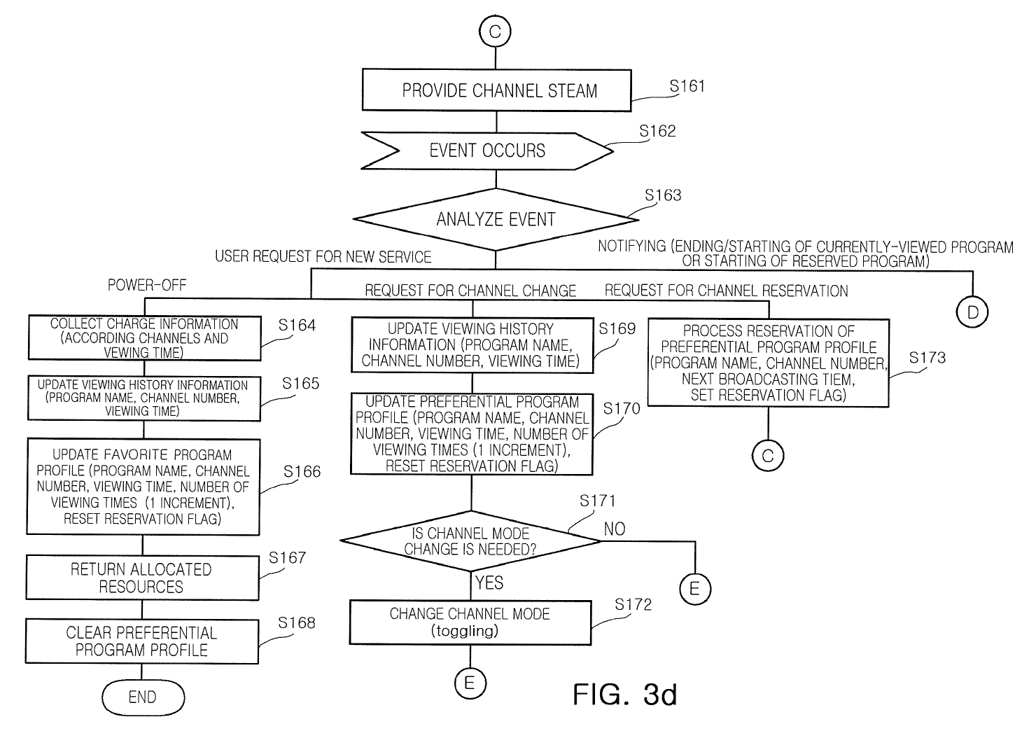

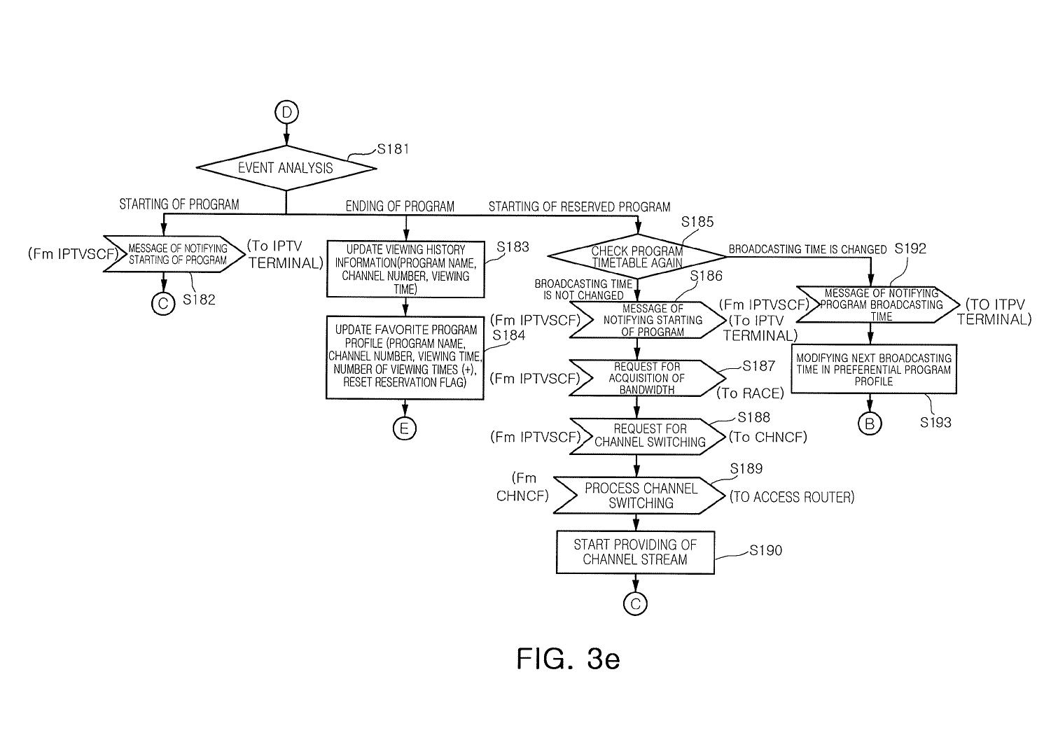

FIGS. 3A to 3E are flowcharts illustrating a channel control method for an IPTV service according to an embodiment of the present invention.

Firstly, an IPTV service access initializing method is described with reference to FIG. 3A.

When the IPTV terminal 200 is powered on (S101), subscriber authentication is performed based on the user ID and the user password (S102). When the authenticated succeeds, the user profile 132 of the authenticated user is loaded on the IPTVSCF 121 (S103).

The service access configuration for the IPTV service is set and initialized based on the user profile 132 (S104). The favorite program profile 124 is loaded on the PCMF 123 (S105).

Next, a channel mode of the IPTV terminal 200 is set to a default channel mode determined at the time of service contract (S106).

If the default channel mode is a basic channel mode (S107), an electronic program guide (EPG) screen is accessed (S107), and the method proceeds to a step A for channel change in the increment-decrement manner.

If the default channel mode is a favorite program mode (S107), the method proceeds to a step B for channel change according to channel preference.

Now, a channel control method in the step A for searching and selection channels in the increment-decrement manner is described with reference to FIG. 3B.

In the A step, if a channel selection signal is input from the IPTV terminal 200, the channel selection signal is analyzed to determine whether the channel of the basic channel controller 212 or the channel of the favorite channel controller 211 is selected.

IF the channel of the favorite channel controller 211 is selected, the method proceeds to the step B for channel change in the favorite channel mode.

If the channel of the basic channel controller 212 is selected, the channel mode is set to the basic channel mode (S123), an access right to the selected channel is verified (S124).

If the access right to the selected access right is verified to be valid, required resources are checked by analyzing terminal performances, contents features, service contracts, and the like based on the user profile 122 (S125), and a bandwidth is required to the RACF 127 (S126).

Next, the CHNCF 135 requests the access router 111 to perform a channel switching process so as for the access router 111 to provide the selected channel to the IPTV terminal 200 (S127 and S128).

The access router 111 receives the stream of the selected channel and provides the stream to the IPTV terminal 200 (S129), and the method proceeds to a step C.

Now, a channel control method in the step B for searching and selection channels according to channel preference is described with reference to FIG. 3C.

In the step B, the channel mode is set favorite channel mode (S141), channel-change-requested days of the week and time periods are checked (S142).

The favorite program profile 124 corresponding to the days of the week is searched (S143), and after that, a program of which preference is highest within the time period is selected as the favorite program (S144).

When the favorite program is selected, the broadcasting time of the program is compared with a broadcasting schedule of the IPTV application server 130 to check whether or not the broadcasting time is changed (S145).

If the broadcasting time of the program is not changed, a message of notifying the starting of the program is transmitted to the IPTV terminal 200 (S146), and bandwidth acquisition is requested (S147). Next, channel switching is processed (S148 and S149).

When the providing of the channel stream to the IPTV terminal 200 starts (S150), the method proceeds to a step C.

If the broadcasting time of the program is changed or cancelled, a message of notifying program broadcasting change is transmitted to the IPTV terminal 200 (S152).

Subsequently, the next broadcasting time of the program is modified, or the program is cleared from the favorite program profile (S153). Next, the method proceeds to the step S144 to search for a program having the next preference.

If a favorite program corresponding to the day of the week or the time period is not searched from the favorite program profile 124, an EPG is connected, and the channel mode is switched to the basic channel mode (S154).

Now, a channel control method in the step C after the providing of the stream of the channel, that is, the channel branching is described with reference to FIG. 3D.

In the step C, during the providing of the channel stream (S161), if a new event occurs (S162), the event is analyzed (S163).

As a result of the analysis of the step S163, if the event is an event of notifying starting or ending of the program or reservation of the program, the method proceeds to a step D. In the step D, the event of notifying the starting or ending of the program or the reservation of the program is processed.

As a result of the analysis of the step S163, if the IPTV terminal 200 is powered off, charge information according to a viewing time after log-in for the programs and the channels is collected, and if needed, the charge information is transferred to an application server (not shown) (S164) Next, viewing history information such as a program name, a channel number, and a viewing time for the latest viewing program is updated (S165).

Next, the favorite program profile 124 is updated based on the updated viewing history information by adding and registering or modifying the program viewed just before the power-off (S166).

For example, if the program viewed just before the power-off is registered as the favorite program, the program name, the channel number, the latest broadcasting time, the next broadcasting time, the latest viewing time, the number of viewing times (=1), and the reservation flag (NO) of the program are stored in the favorite program profile 124.

Next, the resources for transmitting the channel stream allocated by the RACF 127 are returned to the RACF 127 (S167). Next, the favorite program profile clearing is performed to clear programs beyond the set available period from the favorite program profile 124 (S168), and the IPTV service is ended.

As a result of the analysis of the step S163, if the IPTV terminal 200 requests for the channel change, the viewing history information such as a program name, a channel number, and a viewing time of the latest viewing program is updated (S169). Next, the favorite program profile 124 is updated based on the viewing history information (S170).

If the channel requested by the IPTV terminal 200 is not suitable for a currently-set channel mode (S171), the channel mode is changed (for example, the favorite program mode is changed to the basic channel mode, or vise versa) (S172), and after that, the method proceeds to a step E to perform the step 307 of FIG. 3A.

As a result of the analysis of the step S163, if the IPTV terminal 200 requests for reservation of the currently-viewed program, the program is registered in the favorite program profile 124, of the next broadcasting time information is modified, and after that, the reservation flag is set to “YES” (S173) Next, the method proceeds to the step C to continue to provide the stream for the currently-viewed channel.

Now, a channel control method in the step D after the occurrence of the event of notifying the starting or ending of the program or the starting of the reserved program is described with reference to FIG. 3E.

In the step D, the event is firstly analyzed (S181).

If the event is an event of starting the favorite program, a message of notifying starting of the program is transmitted to the IPTV terminal 200 (S182), and the providing of the channel stream starts. Next, the method proceeds to the step C.

If the event is an event of ending the favorite program, the viewing history information is updated based on a program name, a channel number, and a viewing time of the favorite program (S183), and the favorite program profile 124 is also updated based on the aforementioned information (S184). Next, the method proceeds to the step E to perform the step S107 of FIG. 3A.

If the event is an event of starting a reserved program, the broadcasting time of the reserved program is compared with the broadcasting schedule to check whether or not the broadcasting time is changed (S185).

If the broadcasting time is not changed, a message of notifying the starting of the program is transmitted to the IPTV terminal 200 (S186), and a band width is acquired (S187). Next, channel switching is processed (S188 and S189).

When the providing of the channel stream starts (S190), the method proceeds to the step C to continue to receive the channel stream.

If the broadcasting time of the reserved program is changed or cancelled, a message of notifying program broadcasting change is transmitted to the IPTV terminal 200 (S192). Subsequently, the next broadcasting time of the program is modified, or the program is cleared from the favorite program profile (S193). Next, the method proceeds to the step B to search for a program having the next preference.

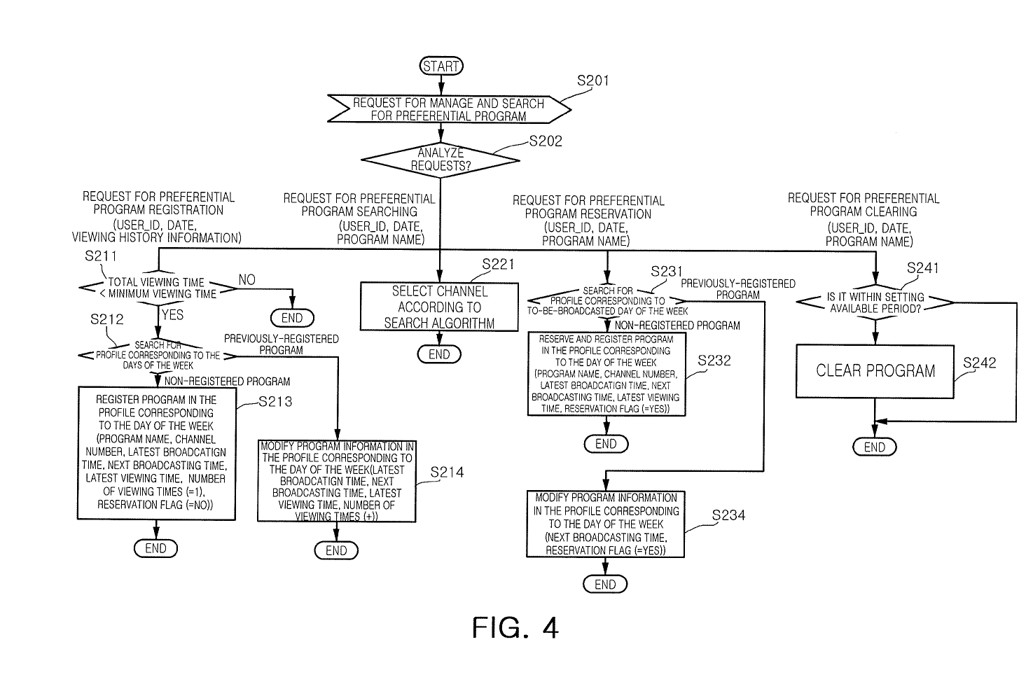

FIG. 4 is a flowchart illustrating a favorite program profile managing method according to an embodiment of the present invention. The favorite program profile managing method is performed every time when the PCMF 123 receives a favorite program registration request, a favorite program searching request, a favorite program reservation request, or profile clearing request from the IPTVSCF 121.

If the IPTVSCF 121 requests for managing and searching for the favorite program (S201), the request of the IPTVSCF 121 is analyzed (S202).

As a result of the analysis of the step S202, if the IPTVSCF 121 requests for registration of the favorite program and provides an user ID, a registration-requested date, and viewing history information, a total viewing time of the registration-requested program is extracted from the viewing history information to check whether or not the total viewing time is longer than a minimum viewing time (for example, five minutes) (S211).

If the total viewing time is shorter than the minimum viewing time, the registration-requested program is treated as a temporarily-viewed program at the time of the channel change, and the registration operation is not performed.

If the total viewing time is longer than the minimum viewing time, the favorite program profile 124 corresponding to the day of the week is searched to check whether or not the program is a previously-registered program (S212). If the program is not registered previously, the program is registered as the favorite program (S213). As a result, the program name, the channel number, the latest broadcasting time, the next broadcasting time, the latest viewing time, the number of viewing times (=1), and the reservation flag (NO) of the program are stored in the favorite program profile 124.

If the program is a previously-registered program, the information of the program such as the latest broadcasting time, the next broadcasting time, the latest viewing time, and the number of viewing times is updated (S214).

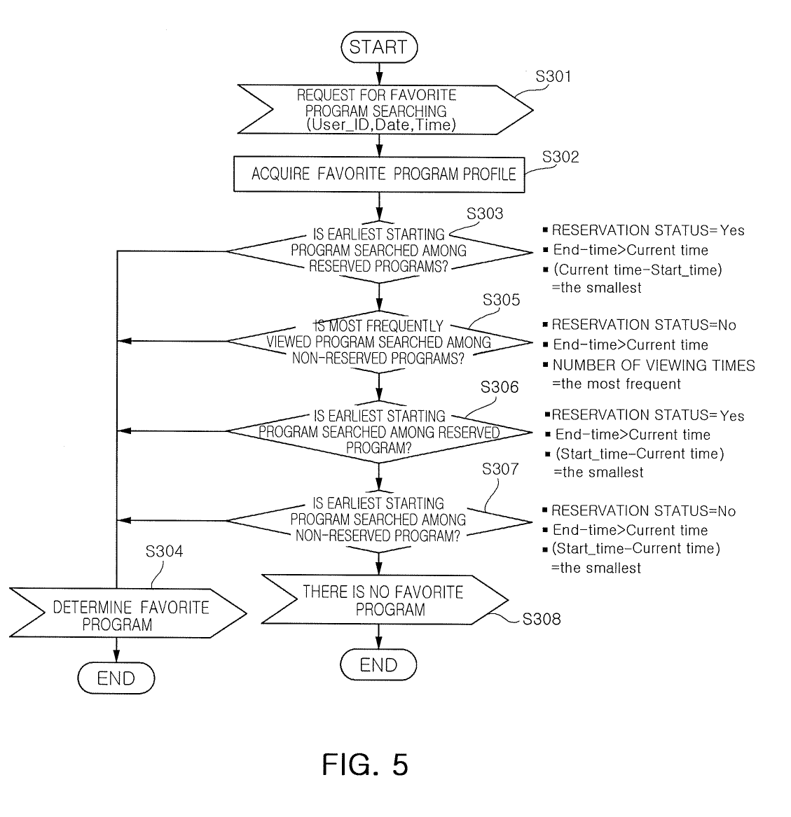

As a result of the analysis of the step S202, if the IPTVSCF 121 requests for searching for the favorite program and provides a user ID and a searching-requested date and time, a program having the highest preference is searched and selected within the days and time period provided from the IPTVSCF 121 by using an searching algorithm according to the present invention (S221). The operation will be described in detail with reference to FIG. 5.

As a result of the analysis of the step S202, if the IPTVSCF 121 requests for reservation of the favorite program, it is checked based on the favorite program file 124 corresponding to the reservation-requested day of the week provided from the IPTVSCF 121 whether or the program is a previously-registered program (S231). If the program is not a previously-registered program, the program is registered as the favorite program, and the reservation flag is set to “YES” (S232). If the program is a previously-registered program, and the next broadcasting time is set, and the reservation flag is set to “YES” (S233).

As a result of the analysis of the step S202, if the IPTVSCF 121 requests for clearing the favorite program profile, it is checked based on the favorite program file 124 corresponding to the reservation-requested day of the week whether or not the latest viewing time of the program is before an set available period (for example, one month) (S241). If the latest viewing time is before the set available period, the program is cleared from the favorite program profile 124 (S242), so that the favorite program profile can be optimized.

The aforementioned favorite program profile clearing operation is performed every time when the reproduction apparatus 230 is powered off.

FIG. 5 is a flowchart illustrating a favorite program searching method according to an embodiment of the present invention. The favorite program searching method is performed every time when the PCMF 123 receives a favorite program searching request.

If the favorite program searching request including the searching-request date and time and the user ID of the user requesting for the favorite program searching is input (S301), the favorite program profile 124 corresponding to the search-requesting date, that is, the search-requested day of the week is searched (S302).

Next, a program that is to start in the time period closest to the search-requested time period for the reserved program is searched (S303). The searched program is set to a favorite program having the highest preference (S304).

Next, a program that is not reserved but is searched among the programs broadcasted in the searching-requested time period (S305), and the searched program is set to a favorite program having the next highest preference (S304).

Next, the earliest starting program among the programs to be stared after the searching-requested time is searched from the reserved programs (S306) The searched program is set to the favorite program having the next preference (S304).

Finally, the earliest starting program among the programs to be started after the time period of the log-in of the user is searched from the non-reserved programs (S307) The searched program is set to the favorite program having the lowest preference (S304).

During the aforementioned operations, if the favorite program is not searched, any favorite program is determined not to be set within the searching-requested day and time period, the basic channel mode is performed (S308).

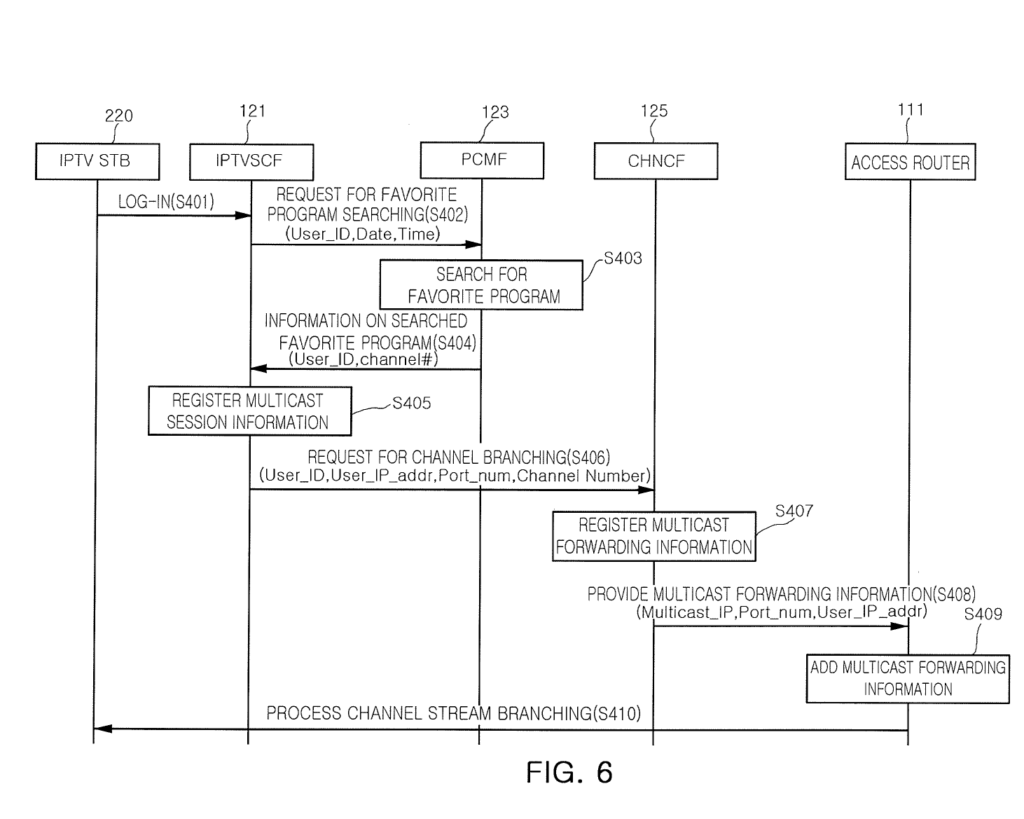

FIG. 6 is a flowchart illustrating a multicast channel branching method according to an embodiment of the present invention.

The IPTV terminal 200 logs in, and an initialization operation for server is performed (S401). Next, the IPTVSCF 121 notifies information on the user ID, the date, and the time to the PCMF 123 based on the user profile 122 and requests for the favorite program searching (S402).

The PCMF 123 searches for the favorite program based on the received information as shown in FIG. 5 (S403). The PCMF 123 transmits information on the searched favorite program such as the user ID and the channel number to the IPTVSCF 121 (S404). The IPTVSCF 121 registers the information to the multicast session information configured as shown in FIG. 2B (S405) Namely, the IPTVSCF 121 adds the IPTV terminal 200 to the user list of the users accessing the searched channel.

The IPTVSCF 121 transmits the user ID, the user IP address, the port number, and the channel number to the CHNCF 125 and requests for the multicast channel branching (S406).

The CHNCF 125 registers the received information to the multicast forwarding information configured as shown in FIG. 2D (S407). Next, the CHNCF 125 provides the information to the access router 111 (S408). The information includes the multicast IP, the port number, and the user IP address.

The access router 111 registers the information received from the CHNCF 125 (S409). Next, the access router 111 performs the channel stream branching based on the information (S410).

Although the multicast channel branching method for the providing of only the favorite program in the favorite channel mode is shown in FIG. 6, the same multicast channel branching method may be applied to the basic channel mode. Namely, when the channels in the basic channel mode is selected by the IPTVSCF 121, the multicast channel branching for the providing of the channel is performed through the steps S405 to S410.

While the present invention has been shown and described in connection with the exemplary embodiments, it will be apparent to those skilled in the art that modifications and variations can be made without departing from the spirit and scope of the invention as defined by the appended claims.

What is claimed is:

1. A channel control method for an IPTV service, comprising:
a mode setting step setting a favorite channel mode and a basic channel mode by analyzing channel change;
a favorite channel control step selecting a channel for favorite programs by searching for only favorite programs in the favorite channel mode;
a basic channel control step selecting the channel by searching for all programs in a sequential order in the basic channel mode; and
a stream providing step providing stream of the selected channel.

2. The channel control method of claim 1, wherein the favorite channel control step comprises:
a favorite program profile acquisition step acquiring a favorite program profile including the favorite programs corresponding to day of the week at the time of channel change, and searching the acquired favorite program profile to acquire favorite programs according to time-based preference at the time of channel change based on the acquired favorite program profile;
a stream providing starting step starting providing the streams of the channel broadcasting the favorite program.

3. The channel control method of claim 2, wherein the favorite program profile is configured according to users and days of the week, and stores information on program names, channel numbers, a latest broadcasting time, a next broadcasting time, a latest viewing time, a number of viewing times, reservation status, and the like in a mapping manner.

4. The channel control method of claim 3, wherein in the favorite program acquisition step, the favorite programs are searched and selected in an order of reserved programs, a most frequently viewed program, an earliest starting program among the reserved programs, and an earliest starting program among non-reserved programs.

5. The channel control method of claim 2, wherein the favorite program acquisition step further comprises, if a favorite program time stored in the favorite program profile is different from a program time of a broadcasting station, updating the favorite program time with the program time of the broadcasting station and proceeding to the stream providing step.

6. The channel control method of claim 1, further comprising:
an event analyzing step detecting and analyzing an event generated at the time of providing the stream of channel;
an access disconnecting step, if the event is a user access disconnecting event, updating viewing history information and the favorite program profile according to viewing programs and performing access disconnecting;
an channel change step, if the event is a channel change event, updating the viewing history information and the favorite program profile, and after that, if the channel mode is changed to the basic channel mode, proceeding to the channel control step, and if not, proceeding to the favorite channel control step to perform the channel change;
a reservation step, if the event is a reservation event, performing reservation and registration of the viewing program in the favorite program profile and, after that, proceeding to the stream providing step.

7. The channel control method of claim 6, further comprising:
a program starting step, if the event is a program starting event, notifying the starting of the selected program and, after that, proceeding to the stream providing step;
a program ending step, if the event is a program ending event, notifying the end of the selected program and updating the viewing history information and the favorite program profile and, after that, proceeding to the mode setting step; and
a reserved program starting step, if the event is a reserved program starting event, notifying the starting of the reserved program and selecting a channel for the reserved program and, after that, proceeding to the stream providing step.

8. The channel control method of claim 1, wherein the stream providing step comprises:
checking a resources request associated with the selected channel and acquiring a bandwidth; and
branching a stream of the selected channel to the user.

9. The channel control method of claim 8, wherein the branching of the stream comprises:
acquiring multicast session information based on information on the selected channel;
updating multicast forwarding information based on the multicast session information; and
branching the streams of the channels based on the multicast forwarding information.

10. The channel control method of claim 9,
wherein the multicast session information is information on users accessing the channels, and
wherein the multicast forwarding information includes information on a plurality of ports corresponding to multicast groups and information on the users accessing the ports.

11. A favorite program profile managing method in an IPTV service system, comprising:
an analyzing step analyzing a request of an IPTV session management apparatus;
a registration step, if the request is a registration request of a specific program, acquiring a favorite program profile corresponding to a registration-requested day of the week and registering the specific program;
a searching step, if the request is a favorite program searching request, acquiring the favorite program profile corresponding to a search-requested day of the week and acquiring favorite programs according to program preference in a search-requested time period;
a reservation step, if the request is a favorite program reservation request, reserving and registering a to-be-reserved program in the favorite program profile corresponding to a reservation-request day of the week.

12. The favorite program profile managing method of claim 11, further comprising a clearing step, if the request is a favorite program profile clearing request, acquiring the favorite program profile corresponding to a clearing-requested day of the week and clearing programs of which latest viewing date is beyond a viewing available period.

13. The favorite program profile managing method of claim 11, wherein the registration step comprises:
receiving a user ID, a date, and viewing history information;
acquiring a viewing time from the viewing history information and determining whether or not the viewing time is longer than a minimum viewing time;
if the viewing time is longer than the minimum viewing time, acquiring the corresponding favorite program profile and determining whether or not a to-be-registered program is previously registered; and
if the to-be-registered program is not previously registered, mapping and storing program names, channel numbers, latest broadcasting time, next broadcasting time, latest viewing time, number of viewing times, reservation flag.

14. The favorite program profile managing method of claim 11, wherein the searching step comprises:
receiving a user ID, a date, and searching-requested time; and
acquiring the favorite program profile and searching and selecting the favorite program in an order of reserved programs, a most frequently viewed program, an earliest starting program among the reserved programs, and an earliest starting program among non-reserved programs.

15. The favorite program profile managing method of claim 11, wherein the reservation step comprises:
receiving a user ID, a date, and a program name; and
acquiring the favorite program profile and mapping and storing program names, channel numbers, a latest broadcasting time, a next broadcasting time, and reservation status in the favorite program profile.

16. An IPTV service system comprising:
a IPTV service controller searching for only favorite programs in an order of time-based preferences at the time of a channel change request according to a favorite channel mode to select channels, sequentially searching for all the channels to select channels, and, after that, configuring multicast forwarding information;
an IPTV application server transmitting channel streams to provide an IPTV service; and
an IPTV transmission network performing channel branching based on the multicast forwarding information.

17. The IPTV service system of claim 16, wherein the IPTV service controller comprises:
a user profile storing user information used for viewing broadcasting channels;
a favorite program profile storing information on time-based favorite programs corresponding to days of the week;
an IPTV session controller checking requests of the user and service environment, monitoring a session status of an access of the user to the broadcasting channels to collect and manage viewing history information;
a favorite program management unit configuring the favorite program profile and searching for and notifying the favorite programs based on the viewing history information under the control of the IPTV session controller; and
a resources/channel controller setting network accessing environment for providing the streams of the selected channels, allocating a bandwidth, and providing the multicast forwarding information.

18. The IPTV service system of claim 17, wherein the favorite program profile stores a channel number, a latest broadcasting time, a next broadcasting time, a latest viewing time, a latest viewing date, a number of viewing times, and a reservation flag for each program in a mapping manner.

19. The IPTV service system of claim 17, wherein the favorite program management unit searches for the favorite programs in an order of reserved programs, a most frequently viewed program, an earliest starting program among the reserved programs, and an earliest starting program among non-reserved programs.

20. The IPTV service system of claim 17, wherein the IPTV session controller does not request registration of favorite programs if the latest viewing time is shorter than a minimum viewing time, and clears a specific program from the favorite program profile if the latest viewing date of the specific program is beyond a set available period.

21. The IPTV service system of claim 16, wherein the multicast forwarding information includes a plurality of ports corresponding to multicast groups and a list of users accessing the plurality of ports.

22. The IPTV service system of claim 16, wherein the IPTV transmission network comprises:
an access router processing channel switching according to the multicast forwarding information; and
an edge router and a core router generating a multicast tree of channels between the IPTV application server and the IPTV terminal.

23. An IPTV terminal comprising:
a channel control apparatus searching for all programs of all channels to select channels or searching for only favorite programs in an order of time-based preferences to select the channels;
an IPTV settop box accessing an IPTV service system and receiving steams of the selected channels from the IPTV service system; and
a reproduction apparatus reproducing the streams of the selected channels.

24. The IPTV terminal of claim 23, wherein the channel control apparatus comprises:
a basic channel controller sequentially searching for all the programs to select to-be-viewed channels; and
a favorite channel controller searching for only favorite programs according to time-based preferences to select the to-be-viewed channels or reserving a currently-viewed programs.
